(19) United States
(12) Patent Application Publication
(10) Pub. No.: US 2011/0247706 A1
(43) Pub. Date: Oct. 13, 2011

(54) Valve device

(75) Inventor: Fu-Hui Wu, Taiping City (TW)

(73) Assignee: Yueng Shing Industrial Co., Ltd.

(21) Appl. No.: 12/798,582

(22) Filed: Apr. 7, 2010

(51) Int. Cl. F16K 15/00

(52) U.S. Cl. 137/535

(57) ABSTRACT

A valve device includes a shell, a primary valve, a check valve, a stop, and a spring. The shell includes an inlet, an outlet, and at least one flange including a cavity in communication with the outlet. The check valve is movably located in the cavity. The check valve includes a stem formed on a side. The stop is located in the cavity so that a gap is defined between the stop and the wall of the cavity. The spring is compressed between the check valve and the stop. The spring includes an end located around the stem of the check valve.

### BACKGROUND OF INVENTION

1. Field of Invention

The present invention relates to a valve device and, more particularly, to a valve device including a check valve.

2. Related Prior Art

Referring to FIGS. 9 and 10, a conventional ball valve device is used together with a conventional check valve device 9. The ball valve device includes a handle 83 operable to spin a ball valve located in a shell 8. The shell 8 includes an inlet 81 and an outlet 82. The check valve device 9 includes a spring-biased check valve 92 located in a shell 91. In assembly, the shell 91 is located between a flange 84 formed around the outlet 82 of the shell 8 and another flange 84.

Combinations as the one discussed above are used in piping. The piping includes pipes cut to lengths according to intended distances between the ball valve devices beforehand. However, the use of the check valve devices 9 requires further cutting of the pipes, and hence increases the cost in assembling the conventional ball and check valve devices and worsens the wear of the pipes.

Moreover, the shell 91 is cast independent of the shell 8. The cost of the shell 91 adds to the total cost of the combination.

Furthermore, in locating the shell 91 between the flanges 84, the center of the check valve 92 must be aligned to the center of the outlet 82. Thus, liquid that goes from the outlet 82 exerts an evenly distributed force on the check valve 92 to push open the check valve 92 without tilting the check vale 92. Otherwise, as clearly shown in FIG. 10, the liquid would exert an unevenly distributed force on the check valve 92 and tilt the check vale 92 so that the flow rate of the liquid would be reduced and the check valve 92 would be damaged. Many attempts have to be made before the center of the check valve 92 can be aligned to the center of the outlet 82.

The present invention is therefore intended to obviate or at least alleviate the problems encountered in prior art.

### SUMMARY OF INVENTION

It is the primary objective of the present invention to provide a robust and inexpensive valve device.

To achieve the foregoing objective, the valve device includes a shell, a primary valve, a check valve, a stop, and a spring. The shell includes an inlet, an outlet, and at least one flange including a cavity in communication with the outlet. The check valve is movably located in the cavity. The check valve includes a stem formed on a side. The stop is located in the cavity so that a gap is defined between the stop and the wall of the cavity. The spring is compressed between the check valve and the stop. The spring includes an end located around the stem of the check valve.

Other objectives, advantages and features of the present invention will be apparent from the following description referring to the attached drawings.

### BRIEF DESCRIPTION OF DRAWINGS

The present invention will be described via detailed illustration of four embodiments versus the prior art referring to the drawings wherein:

FIG. 1 is an exploded view of a valve device according to the first embodiment of the present invention;

FIG. 2 is a cross-sectional view of the valve device shown in FIG. 1;

FIG. 3 is a cross-sectional view of the valve device shown in FIG. 1, with liquid traveling through it in a direction;

FIG. 4 is a cross-sectional view of the valve device shown in FIG. 1, preventing liquid from traveling through it in an opposite direction;

FIG. 5 is an exploded view of a valve device according to the second embodiment of the present invention;

FIG. 6 is a cross-sectional view of the valve device shown in FIG. 5;

FIG. 7 is a cross-sectional view of a valve device according to the third embodiment of the present invention;

FIG. 8 is a cross-sectional view of a valve device according to the fourth embodiment of the present invention;

FIG. 9 is an exploded view of a conventional ball valve device used with a check valve device; and

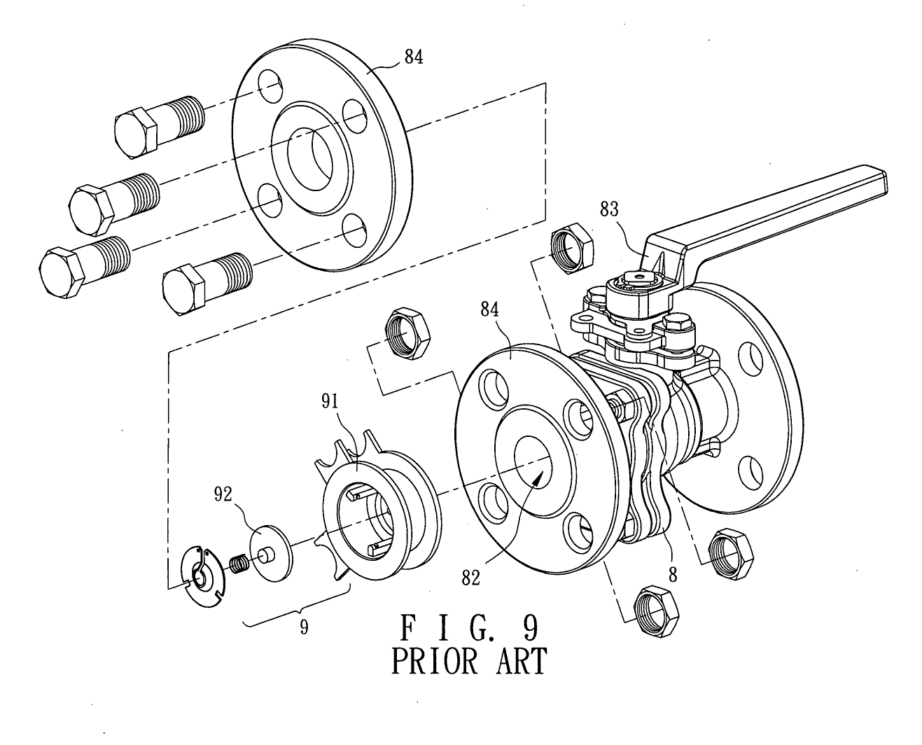

FIG. 10 is a cross-sectional view of the conventional ball valve device and the check valve device shown in FIG. 9.

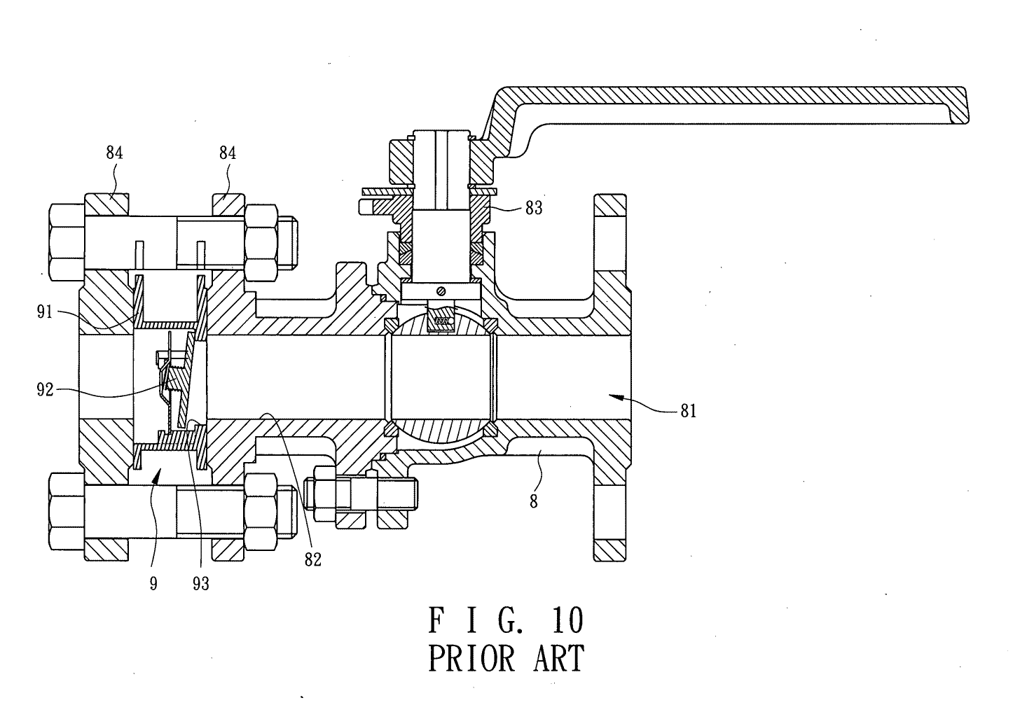

### DETAILED DESCRIPTION OF EMBODIMENTS

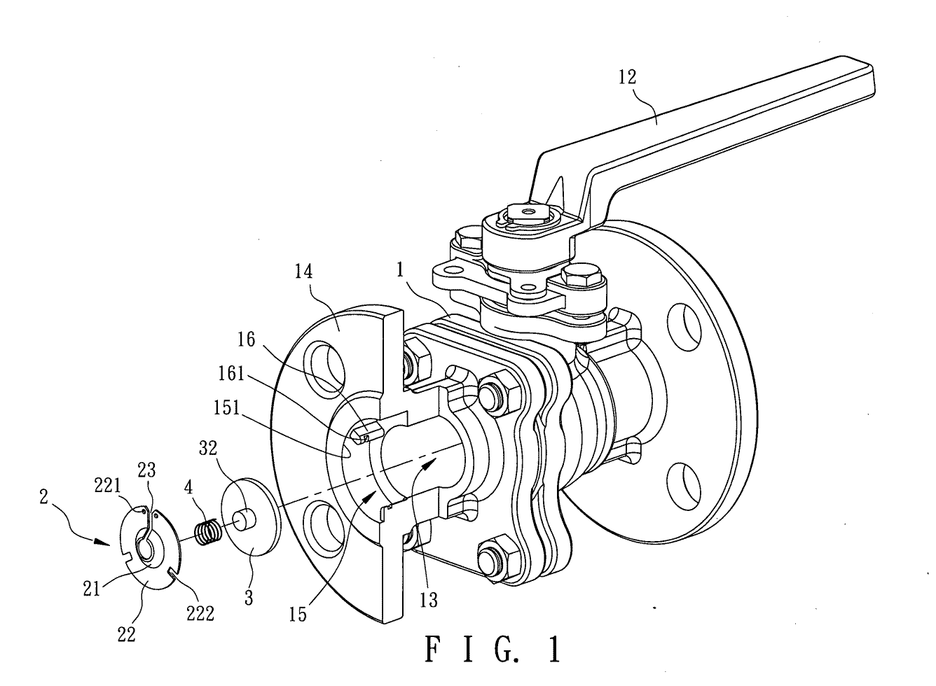

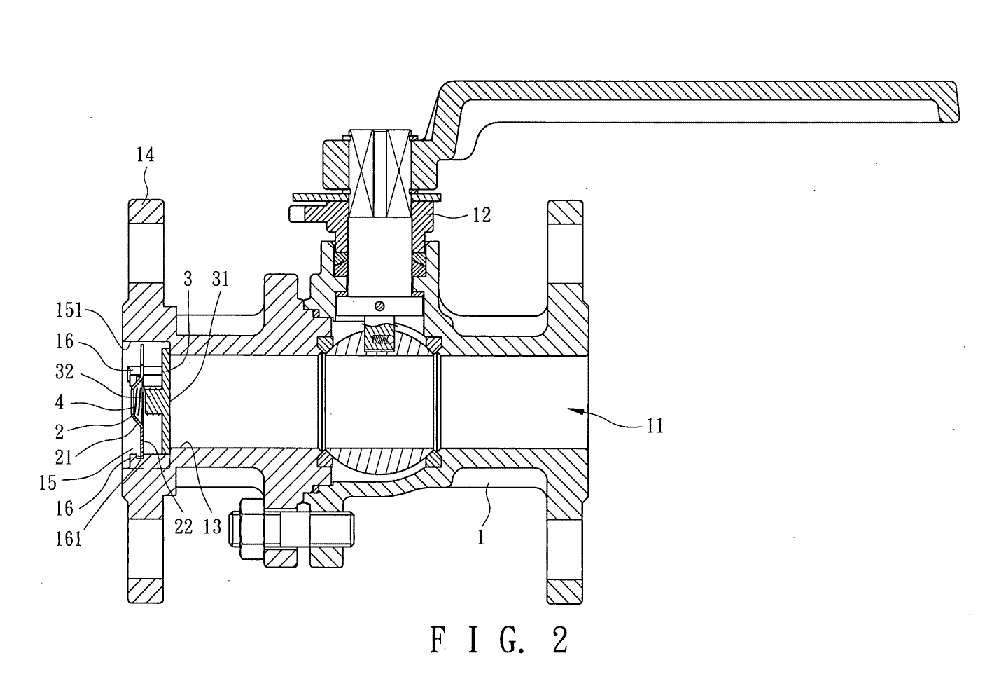

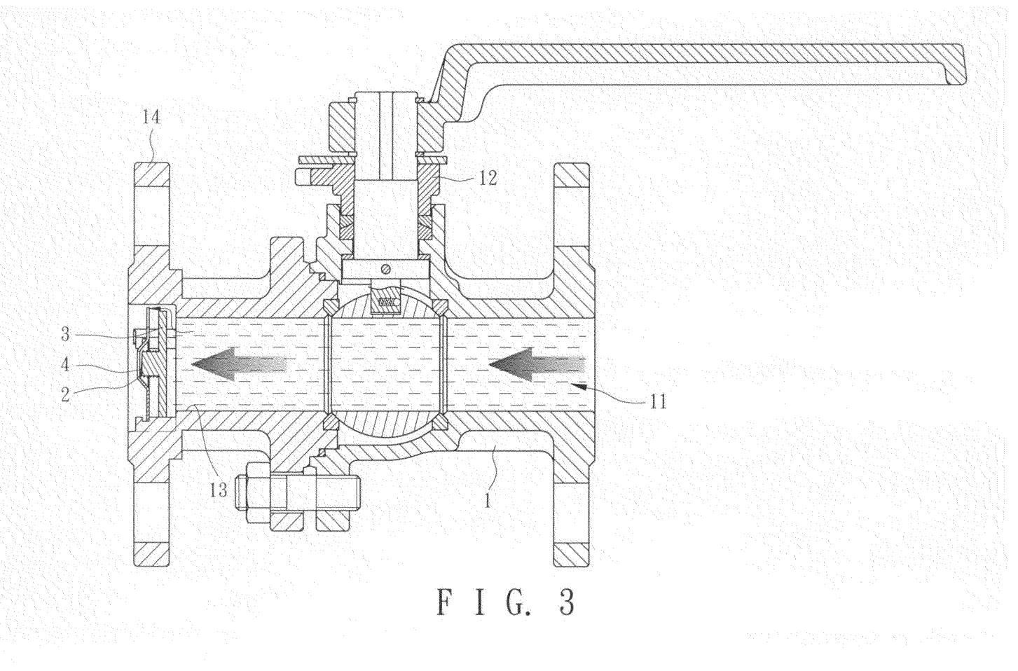

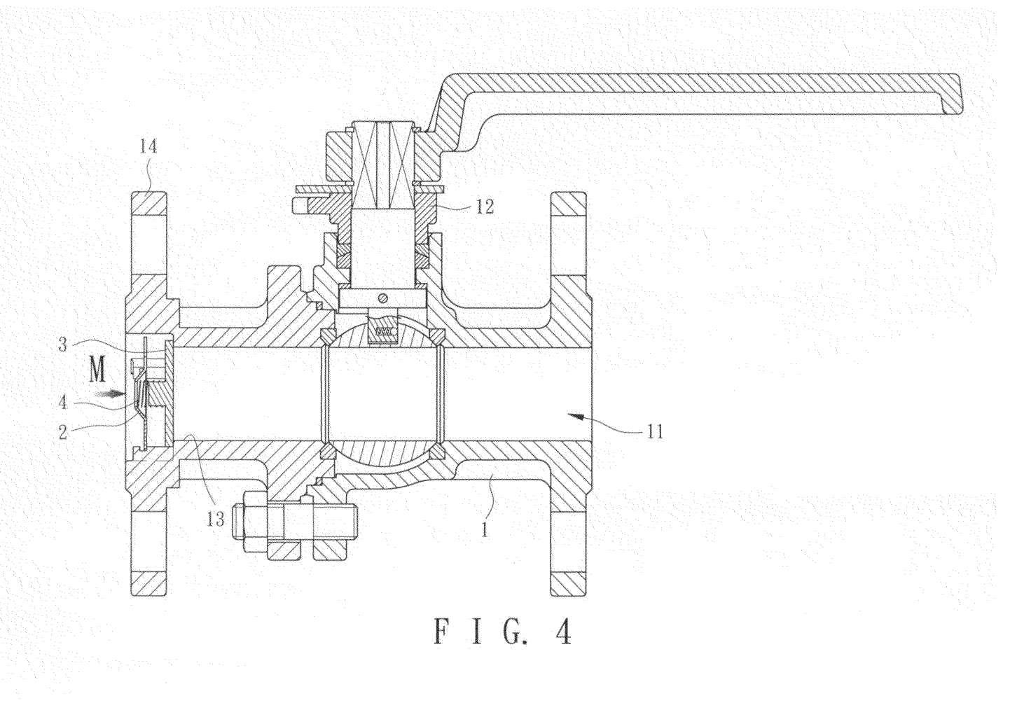

Referring to FIGS. 1 through 4, a valve device includes a single shell 1 for containing a ball valve and a check valve 3 according to a first embodiment of the present invention. The shell 1 includes two flanges 14 each of which can be connected to a flange formed at an end of a pipe with screws and nuts so that the valve device is connected to the pipe. There is provided a handle 12 operable to spin the ball valve to control the flow rate of liquid going through the valve device. The shell 1 includes a tunnel defined therein. The tunnel includes an inlet 11 and an outlet 13. Furthermore, the shell 1 includes a cavity 15 in communication with the outlet 13. The center of the cavity 15 is aligned to the center of the outlet 13 during the making of the shell 1. There are ribs 16 formed on the wall 151 of the cavity 15 evenly. Each of the ribs 16 extends in parallel to the axis of the tunnel of the shell 1. A recess 161 is defined in each of the ribs 16.

The check valve 3 is a disc with a contact face 31 formed on a side and a stem 32 centrally formed on an opposite side. The contact face 31 can encounter the liquid. The diameter of the check valve 3 is larger than that of the outlet 13 so that the check valve 3 can block the outlet 13. The check valve 3 is movably located in the cavity 15.

There is provided a spring 4 that is preferably a compression spring in the form of a helical spring. The spring 4 is also located in the cavity 15.

There is provided a stop 2 including a peripheral portion 22 extending from a central portion 21. The central portion 21 of the stop 2 is in the form of a conical frustum with an aperture defined therein centrally. The peripheral portion 22 of the stop 2 extends in a plane. There is a slit 23 extending throughout the central and peripheral portions of the stop 2 along a radius. There are apertures 221 defined in the peripheral portion 22 of the stop 2 so that the slit 23 is located between the apertures 221. There are cutouts 222 defined in the peripheral portion 22 of the stop 2 corresponding to the ribs 16. One of the cutouts 222 is in communication with the slit 23.

In assembly, tongues are inserted in the apertures 221 and operated to reduce the width of the slit 23, i.e., the size of the stop 2, and move the stop 2 into the cavity 15. Each of the cutouts 222 receives a related one of the ribs 16. The peripheral portion 22 of the stop 2 is located in the recesses 161 of the ribs 16. Finally, the tongues are removed from the apertures 221 to allow the stop 2 to extend. The stop 2 cannot be spun since the cutouts 222 receive the ribs 16. The stop 2 cannot be moved axially because the peripheral portion 22 thereof is located in the recesses 161. There is a gap defined between the stop 2 and the wall 151 of the cavity 15, and the liquid can go through this gap.

The spring 4 is compressed between the stop 2 and the check valve 3. A first end of the spring 4 is located in the central portion 21 of the stop 2 while a second end of the spring 4 is located around the stem 32.

Advantageously, the center of the stop 2 is aligned to the center of the cavity 15, which is aligned to the center of the outlet 13. The center of the spring 4 is aligned to the center of the stop 2 since the first end of the spring 4 is located in the central portion 21 of the stop 2. The center of the check valve 3 is aligned to the center of the spring 4 because the stem 32 centrally formed on the check valve 3 is fit in a second end of the spring 4. Moreover, the ribs 16 together define a circle that is coaxial with the outlet 13 and substantially identical to the periphery of the check valve 3. Thus, the center of the check valve 3 is aligned to the center of the outlet 13 so that liquid going from the outlet 13 exerts an evenly distributed force on the check valve 3. Moreover, the spring 4 exerts an axial force on the check valve 3. Hence, the check valve 3 can be moved axially in the cavity 15 but cannot be tilted.

Also advantageously, the location of the check valve 3, the spring 4 and the stop 2 in the shell 1 is easy. Moreover, the inclusion of the check valve 3, the spring 4 and the stop 2 does not require increasing of the length of the shell 1. Therefore, a pipe between two valve devices of the present invention does not have to be cut again just because the check valves are included in the valve devices.

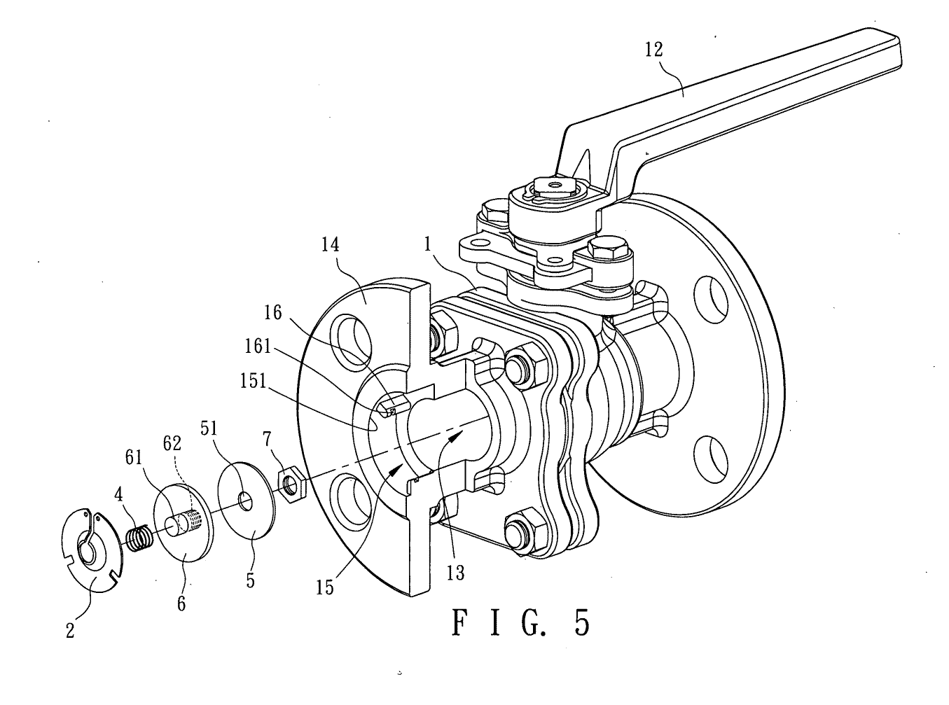

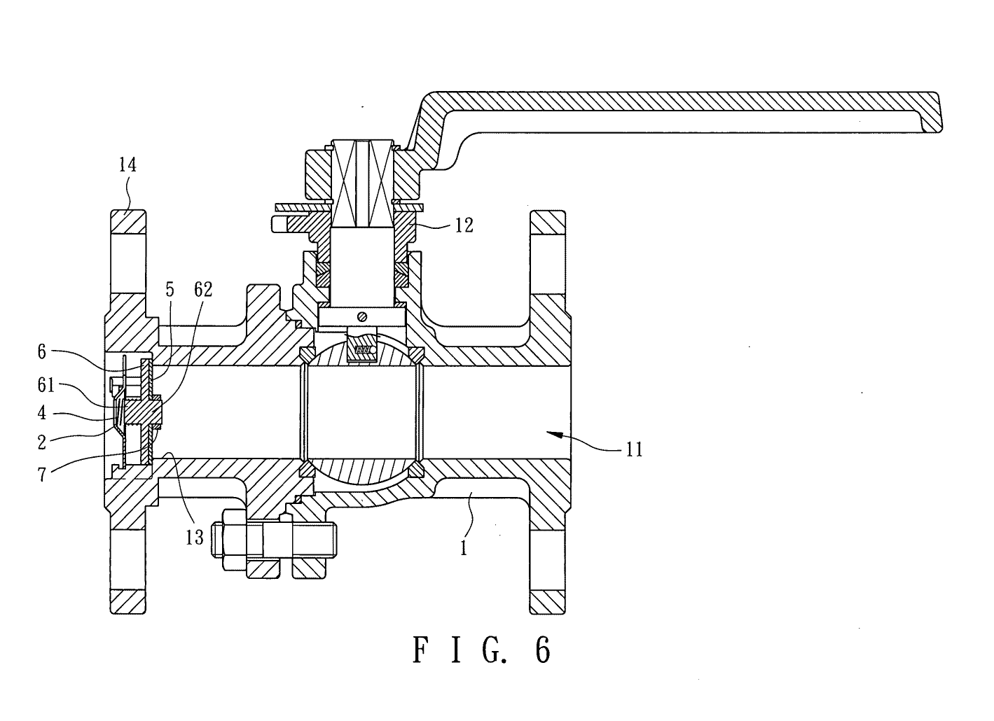

Referring to FIGS. 5 and 6, there is shown a valve device according to a second embodiment of the present invention. The second embodiment is like the first embodiment except including a check valve 5, a supportive disc 6 and a nut 7 instead of the check valve 3. The supportive disc 6 includes a screw 62 centrally formed on a side and a stem 61 centrally formed on an opposite side. The check valve 5 is made of a flexible material. The check valve 5 includes an aperture 51 centrally defined therein. The screw 62 is inserted through the aperture 51 and engaged with the nut 7. Thus; the check valve 5 is attached to the supportive disc 6.

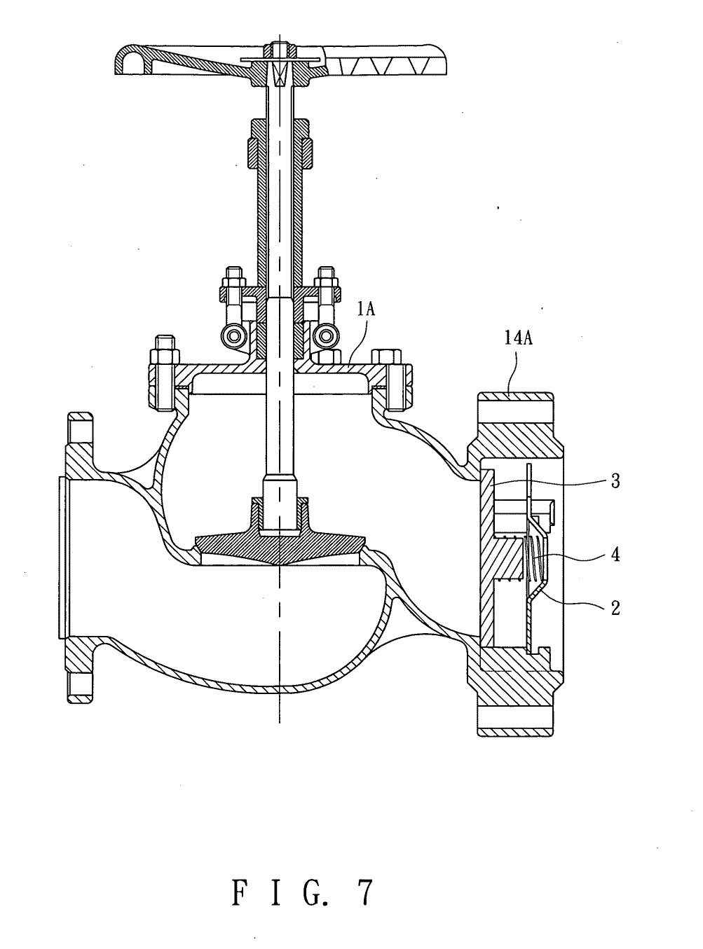

Referring to FIG. 7, there is shown a valve device according to a third embodiment of the present invention. The third embodiment is like the first embodiment except the check valve 3, the spring 4 and the stop 2 are used in a flange 14A of a valve device 1A of another type.

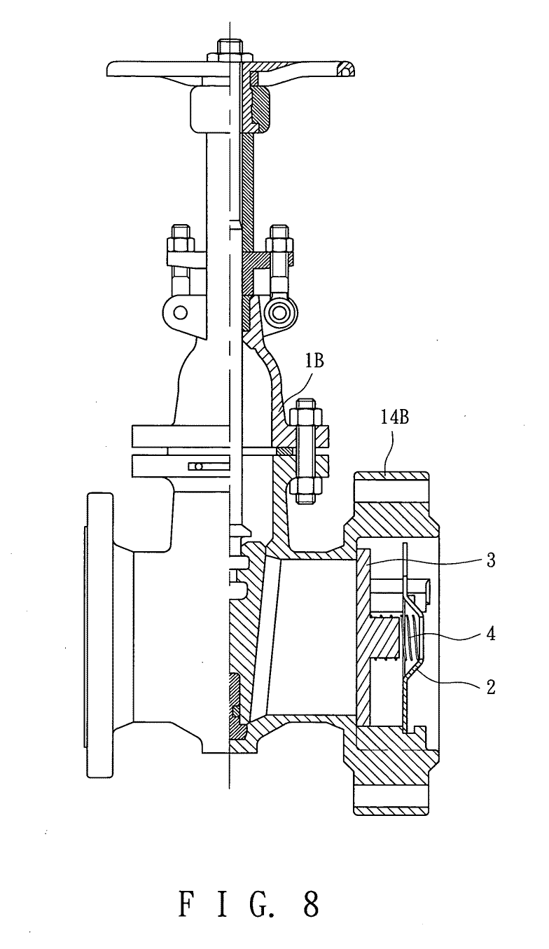

Referring to FIG. 8, there is shown a valve device according to a fourth embodiment of the present invention. The third embodiment is like the first embodiment except the check valve 3, the spring 4 and the stop 2 are used in a flange 14B of a valve device 1B of another type.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A valve device including:
a shell including an inlet (11), an outlet (13), and at least one flange (14) including in communication with the outlet (13), wherein the cavity (15) is defined by a wall (151);
a check valve (3, 5) movably located in the cavity (15);
a stop (2) located in the cavity (15) so that a gap is defined between the stop (2) and the wall (151) of the cavity (15); and
a spring (4) compressed between the check valve (3, 5) and the stop (2).

2. The valve device according to claim 1, wherein the shell (1) includes at least two ribs (16) formed on the wall (151) of the cavity (15), wherein each of the ribs (16) includes a recess (161) for receiving the stop (2).

3. The valve device according to claim 2, wherein the stop (2) includes at least two cutouts (222) each for receiving a related one of the ribs (16).

4. The valve device according to claim 1, wherein the check valve (3) includes a stem (32) fit in an end of the spring (4).

5. The valve device according to claim 1, wherein the check valve (5) is made of a flexible material.

6. The valve device according to claim 5 further including a supportive disc (6) with a side attached to the check valve (5) and an opposite side abutted against the spring (4).

7. The valve device according to claim 6, wherein the supportive disc (6) includes a stem (61) fit in an end of the spring (4).

8. The valve device according to claim 6, wherein the supportive disc (6) includes a screw (62) driven through the check valve (5).

9. The valve device according to claim 8, wherein the check valve (5) includes an aperture (51) through which the screw (62) is inserted.

10. The valve device according to claim 9 further including nut (7) engaged with the screw (62).
